(19) United States
(12) Patent Application Publication
(10) Pub. No.: US 2005/0186025 A1
(43) Pub. Date: Aug. 25, 2005

(54) Tube conjoinment structure

(76) Inventor: Ren-Ju Tzeng, Changhua Hsien (TW)

Correspondence Address: RABIN & BERDO, P.C., Suite 500, 1101 14th Street, N.W., Washington, DC, 20005, US

(21) Appl. No.: 10/782,848

(22) Filed: Feb. 23, 2004

(51) Int. Cl. F16B 1/00; G12B 9/00

(52) U.S. Cl. 403/205

(57) ABSTRACT

A tube conjoinment structure comprised of symmetrical tubular support members along with a plurality of connecting components and a plurality of bolts. A plurality of through-holes are formed near the union ends. A plurality of threaded holes are tapped at a predetermined area of the connecting components and a recess hole of an appropriate depth is formed at the end edge of each threaded hole to enable the initial entry of the bolts. A collar is disposed at a suitable section of each bolt such that to rotate the bolts in the opposite direction, allowing the bolt collars to be tightened in place against the inner wall of the tubular support member.

### BACKGROUND OF THE INVENTION

1) Field of the Invention

The invention herein relates to DIY assembly products, specifically a tube conjoinment structure that provides for use with furnishings made of steel tubing and the installation thereof.

2) Description of the Prior Art

In the storage or multi-level shelves observed today, the support members are typically conjoined with connecting components and screws. However, after such prior art shelves are assembled, all the screws are exposed on the tubular walls of the support members, greatly detracting from the general appearance of the assembled structure and, furthermore, to keep the heads of the installed screws even with the tubular walls of the support members, dish-shaped or countersunk holes must be drilled in the support members in addition to the screw holes for the purpose of leveling the installed screw heads with the support member tubular walls. However, the screws become even more visibly conspicuous and, furthermore, the dish-shaped or countersunk hole finishing procedures increase production costs and are really not worth the effort because the higher production overhead is a disadvantage to market competitiveness.

Therefore, the applicant of the invention herein, deeply aware of the shortcomings of the prior art, conducted extensive research and development based on many years of experience gained while engaged in the field that culminated in the successful completion of the invention herein, which is submitted in application for patent rights.

### SUMMARY OF THE INVENTION

The objective of the invention herein is to provide a tube conjoinment structure in which a plurality of threaded holes are tapped at a predetermined area of the connecting components and a recess hole of an appropriate depth is formed at the end edge of each threaded hole to provide for the initial entry of bolts; after the connecting component and tubular support member union end are inserted together, a hexagonal wrench is admitted into through-holes to rotate the bolts in the opposite direction, allowing the bolt collars to be tightened in place against the inner wall of the tubular support member; as such, the bolts are completely concealed in the tubular support member, the present invention thereby enabling the simple assembly of structures appropriate for current DIY assembly products, while also saving considerable production costs and affording an overall design of greatly enhanced exterior appearance.

To enable a further understanding of the structural features and operation of the present invention, the brief description of the drawings below are followed by the detailed description of the invention herein.

### BRIEF DESCRIPTION OF THE DRAWINGS

FIG. 1 is an exploded drawing of invention herein, partial view.

FIG. 2 is an isometric drawing of the invention herein illustrating the assembly.

FIG. 3 is an isometric drawing of the invention herein illustrating the assembly in a partial view.

FIG. 4 is a section drawing of the perspective of line 4-4 along FIG. 3.

FIG. 4A is the drawing of FIG. 4 relating to the bolt rotating anti-clockwise direction and in a locking condition to tubular support member.

FIG. 5 is an exploded drawing of an embodiment of the tubular support member and bolt of the invention herein.

FIG. 5A is an isometric drawing of the tubular support member of FIG. 5.

FIG. 6 is a section drawing of the perspective of line 6-6 along FIG. 5A.

FIG. 6A is the drawing of FIG. 6 relating to the bolt rotating anti-clockwise direction and in a locking condition to tubular support member.

FIG. 7 is an isometric drawing of an embodiment of the invention herein.

### DETAILED DESCRIPTION OF THE INVENTION

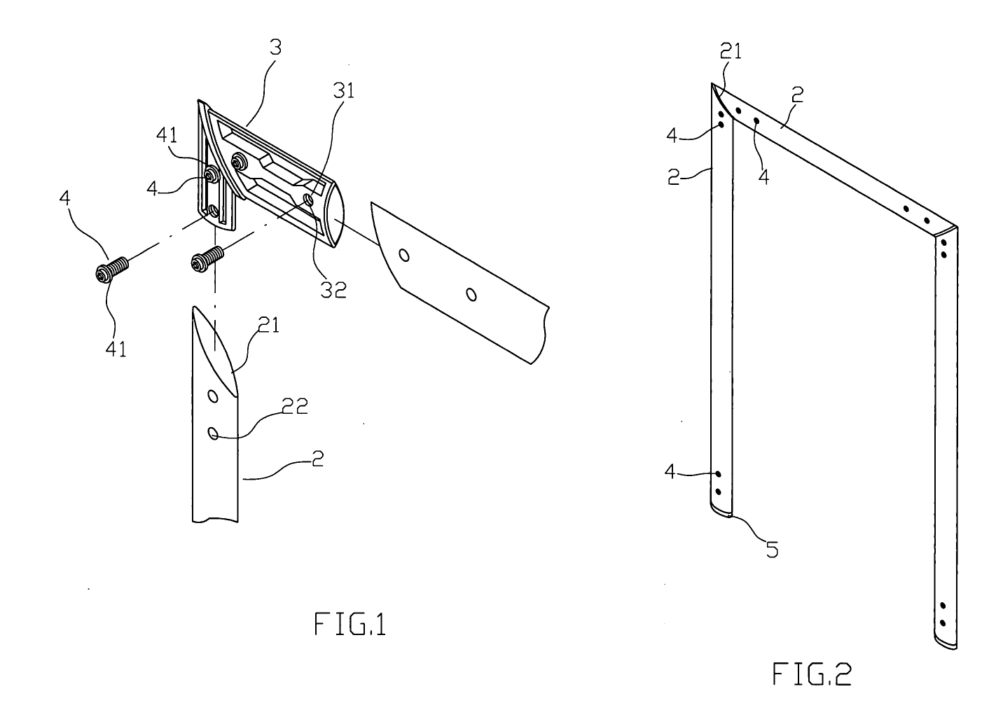

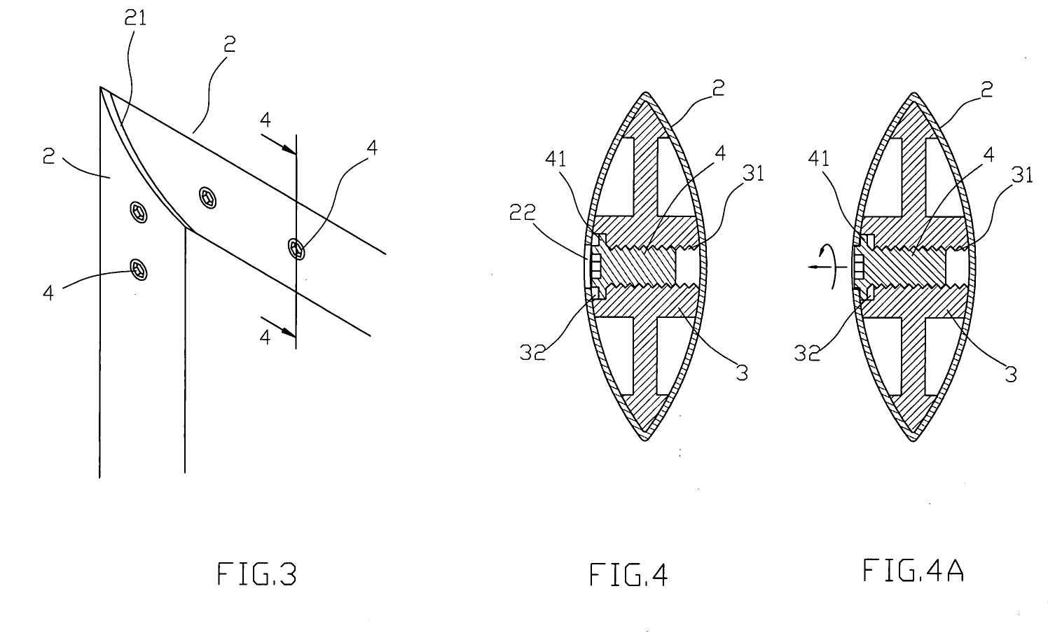

Referring to FIG. 1 and FIG. 2, the invention herein is comprised of symmetrical tubular support members 2 along with a plurality of connecting components 3 and a plurality of bolts 4; a 45-degree angled side 21 is disposed at the union ends of the tubular support members 2 and a plurality of through-holes 22 are formed at a predetermined area near the union ends; each connecting component 3 is of one-piece construction and fabricated to accommodate the insertion of the tubular support member 2 union ends; a plurality of threaded holes 31 are tapped at a predetermined area of the connecting components 3 and a recess hole 32 of an appropriate depth is formed at the end edge of each threaded hole 31 to provide for the initial entry of the bolts 4; a collar 41 is disposed at a suitable section of each said bolt 4 such that when initially admitted into the connecting component 3 threaded hole 31, the said collar 41 is first held in the recess hole 32 until the connecting component 3 and tubular support member 2 union end are inserted together, following which a hexagonal wrench is admitted into the through-holes 22 to rotate the bolts 4 in the opposite direction, allowing the bolt 4 collars 41 to be tightened in place against the inner wall of the tubular support member 2 (as shown in FIG. 4 and FIG. 4A) and, as such, the bolts 4 are completely concealed in the tubular support member 2 and brought flush with the tubular walls of another tubular support member 2, thereby enabling the simple assembly of structures appropriate for current DIY assembly products, while also saving considerable production cost.

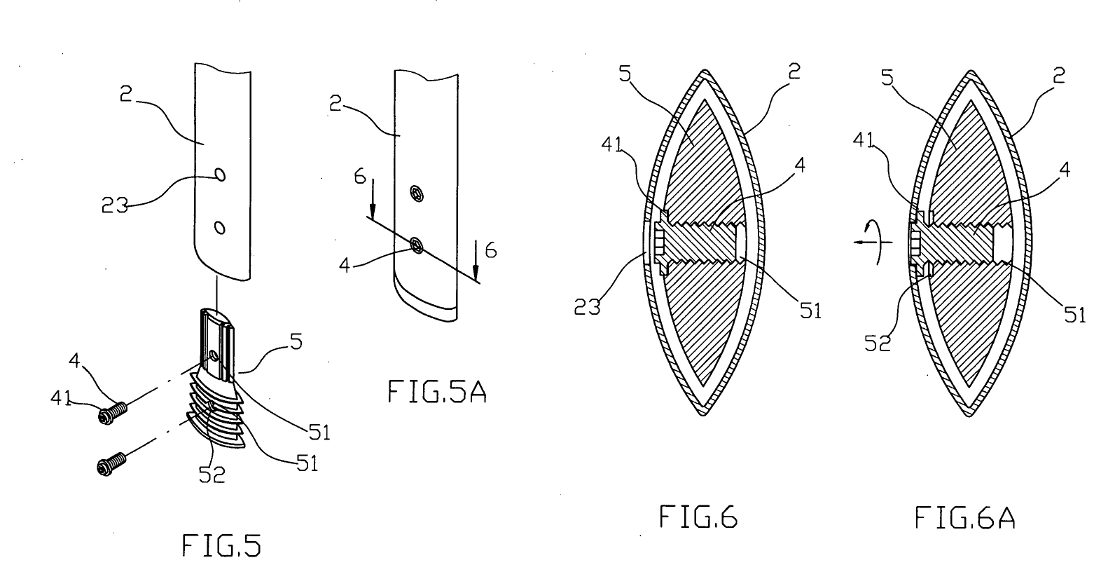

Referring to FIG. 5 and FIG. 5A, a plurality of through-holes 23 are formed near the foot end of the said tubular support member 2, and a leg insert 5 of one-piece construction is fabricated to be fitted into the tubular support member 2 foot end; a plurality of threaded holes 51 are tapped at a predetermined area of the leg insert 5 and a recess hole 52 of an appropriate depth is formed at the end edge of the threaded holes 51 to provide for the initial entry of the bolts 4; a collar 41 is disposed at a suitable section of each said bolt 4 such that when initially admitted into the leg insert 5 threaded hole 51, the said collar 41 is first held in the recess hole 52, until the leg insert 5 and tubular support member 2 foot end are inserted together, following which a hexagonal wrench is admitted into the through-holes 23 to rotate the bolts 4 in the opposite direction, allowing the bolt 4 collars 41 to be tightened in place against the inner wall of the tubular support member 2 (as shown in FIG. 6 and FIG. 6A) and, as such, the bolts 4 are completely concealed in the tubular support member 2.

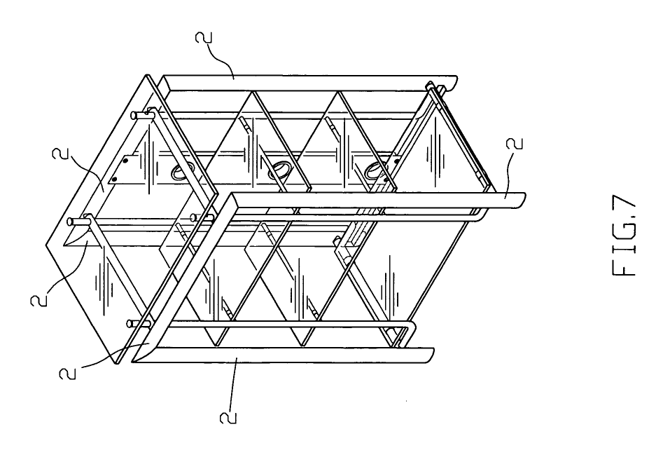

Finally, referring to FIG. 7, the conjoinment structure of the present invention enhances appearance at unsightly visible bolt 4 fastened positions, while also saving production and assembly time.

In summation of the foregoing section, the structural arrangement of the invention herein serves as the basis the embodiments herein, is easy to assemble and utilize and also versatile and of greater attractiveness; furthermore, the present invention is fully developed and if the examination committee does not understand any aspect of the invention herein, an operational sample will be provided to the bureau upon written request to facilitate review and the granting of the commensurate patent rights.

1. A tube conjoinment structure comprised of symmetrical tubular support members along with a plurality of connecting components and a plurality of bolts; a 45-degree angled side is disposed at the union ends of the said tubular support members and a plurality of through-holes are formed at a predetermined area near the union ends; each said connecting component is of one-piece construction and fabricated to accommodate the insertion of the said tubular support member union ends, the features of which are: A plurality of threaded holes are tapped at a predetermined area of the said connecting components and a recess hole of an appropriate depth is formed at the end edge of each said threaded hole to provide for the initial entry of the said bolts; a collar is disposed at a suitable section of each said bolt such that when initially admitted into the said connecting component threaded hole, the said collar is first held in the said recess hole until the said connecting component and the said tubular support member union end are inserted together, following which a hexagonal wrench is admitted into the said through-holes to rotate the said bolts in the opposite direction, allowing the said bolt collars to be tightened in place against the inner wall of the said tubular support member.

2. A tube conjoinment structure comprised of the said tubular support members, leg inserts, and the said plurality of bolts; a plurality of through-holes are formed near the foot end of the said tubular support member, and the said leg insert is of one-piece construction and fabricated to be fitted into the said tubular support member foot end, the features of which are: A plurality of threaded holes are tapped at a predetermined area of the said leg insert, a recess hole of an appropriate depth is formed at the end edge of the said threaded holes to provide for the initial entry of the said bolts; the said collar is disposed at a suitable section of each said bolt such that when initially admitted into the leg insert threaded hole, the said collar is first held in the said recess hole, until the said leg insert and the said tubular support member foot end are inserted together, following which a hexagonal wrench is admitted into through-holes to rotate the said bolts in the opposite direction, allowing the said bolt collars to be tightened in place against the inner wall of the said tubular support member.
